(19) United States
(12) Patent Application Publication
(10) Pub. No.: US 2004/0213463 A1
(43) Pub. Date: Oct. 28, 2004

(54) Multiplexed, spatially encoded illumination system for determining imaging and range estimation

(76) Inventor: Rick Lee Morrison, Naperville, IL (US)

Correspondence Address: Rick L. Morrison, Distant Focus Corporation, 60 Hazelwood Drive, Champaign, IL, 61820

(21) Appl. No.: 10/709,227

(22) Filed: Apr. 22, 2004

Related U.S. Application Data
(60) Provisional application No. 60/464,346, filed on Apr. 22, 2003.

(51) Int. Cl. G06K 9/00; G06K 9/76

(52) U.S. Cl. 382/210; 382/154; 382/106

(57) ABSTRACT

A illumination device sequentially projects a selective set of spatially encoded intensity light pulses toward a scene. The spatially encoded patterns are generated by an array of diffractive optical or holographic elements on a substrate that is rapidly translated in the path of the light beam. Alternatively, addressable micromirror arrays or similar technology are used to manipulate the beam wavefront. Reflected light is collected onto an individual photosensor or a very small set of high performance photodetectors. A data processor collects a complete set of signals associated with the encoded pattern set. The sampled signals are combined by a data processing unit in a prescribed manner to calculate range estimates and imaging features for elements in the scene. The invention may also be used to generate three dimensional reconstructions.

### FEDERAL RESEARCH STATEMENT

Not applicable.

### Background of Invention

1. Field of Invention

This invention enables the imaging and the range estimation of elements within a scene using a light source that generates a sequentially projected set of spatially encoded illumination patterns, a simple receiver, and a data processing device with associated program.

2. Description of Prior Art

One conventional method for acquiring a digital image of a scene is to use an optical system to collect and focus light reflected or emitted from objects such that an image is formed on a two-dimensional focal plane array of photo-sensors, such as a CCD or CMOS sensor. This system produces a one-to-one correspondence between pixels (picture elements) and physical elements in the scene. When two images are acquired differing only by a modest translation of the camera, the distance or range to objects in the field can be determined from the apparent parallax. Accuracy improves with increasing lateral displacement, however, a fully automated correlation of all elements through-out the scene is a difficult data processing task. Thus digital range-finder devices are rarely implemented to collect range estimations and image acquisition simultaneously throughout a scene.

One method for determining an object's range is to measure the time of flight for a laser beam pulse to be emitted, reflected, and then received by a high-speed photodetector. This light detection and ranging system is often referred to as either LIDAR or LADAR. The range is approximately one half the time difference between pulse emission and detection of the reflected light divided by the speed of light in air plus any corrections when the emission and detector units are separately located.

The invention described in this document integrates the functionality of both LIDAR and the digital camera, but considerably reduces the system complexity by requiring only a single or small number of photo-sensors.

A pulsed laser beam is typically used in a LIDAR system since it produces a focused, intense spot of light with well defined time characteristics. The light pulse can be generated by several means, such as by modulating the laser's electrical power source, or by mechanically shuttering the light beam, or by using saturation and amplification properties of components in the laser cavity. The time of flight can be determined by measuring the time delay of the detected waveform between emission and return. Photosensors or amplified photo-detectors, such as photomultiplier tubes or avalanche photodiodes are typically used to convert the optical signal into an electronic signal. Alternatively, when the time delay between light pulses in a periodic sequence is monotonically decreased or increased (a method referred to as signal chirping), combining the source and detection signals generates a secondary frequency component that can be used to indicate the range.

Unfortunately, the LIDAR method as just described measures the range to a single isolated location illuminated by the light beam and does not typically measure the relative reflectivity of the element. If the ranges of several locations in a scene are to be measured, it is necessary to deflect the beam to each location sequentially. Frequently, these measurements are taken by either scanning the light beam along two orthogonal dimensions using a set of computer actuated mirrors, or the beam is scanned along one dimension while the scanning system travels along the other dimension. The first procedure might be used to scan a room with a stationary instrument, while the second procedure might be used by a device flown in an aircraft to map surface elevations. Typically a data processing system would be used to collect and determine the range information associated with each location and present the dataset in a manner that can be understood by an observer.

It has been shown that it is possible to collect both image and range data sets simultaneously. Let us define an image to be a two-dimensional display of picture elements (pixels) whose intensity or value is correlated with the amount of light reflected by an object element. In conventional digital photography, the entire pixel array is collected simultaneously using imaging optics and a focal plane sensor array. In these situations, illumination is relatively constant and uniform over a scene. One means of simultaneously collecting image and range information would be to build a system with a pulsed illuminator and a high spatial resolution array of photosensitive elements where the elements measures both the magnitude and temporal characteristics of the image. Unfortunately, the complexity of building such a photosensitive array makes this endeavor either quite expensive or impractical at the time of this patent submission.

Another means of obtaining range estimates and imaging information simultaneously is to use a pulsed illuminator and an electronically gated “light valve” that permits only light arriving during a specified time duration window to be collected. The range information is determined by collecting a sequence of images where the gated time window is methodically scanned through a series of time delays. The range resolution however, is limited by the minimum gate resolution which is currently on the order of a few nanoseconds, or equivalently, a few feet in length. In addition, the time required to analyze a large field of range can be considerably long. Still, there are commercial imaging systems employing such gated microchannel photo-amplifiers.

Finally, some commercially available single beam laser scanning systems simply measure the signal power as well as the time delay at each pixel location and convert this power into a pixel intensity after correcting for the power fall off with distance. Although the complete range estimation and imaging process is accurate, the galvanometers are typically fragile and are not fit for use in many situations.

This brings us to a technique used in astronomy and spectroscopy that bears elements of similarity to the invention. It is referred to as the multiplexed imaging or coded aperture camera concept. In these systems, a sequence of coded amplitude masks are inserted into the collection aperture of the optical system of a camera system while signals are acquired. Through an appropriate combination of the collected signals, a specific feature can be extracted from the data. The encoded aperture typically replaces the optical focusing elements and provides advantages in light throughput that increases the mean power per measurement and improve the signal to noise ratio. Our invention differs significantly in that an active spatially encoded pulsed illumination system is used in stead of the spatially encoded receiver aperture. Also, a temporal analysis of the reflected light provides an additional dimension (range) of information.

### Objects and Advantages

Several objects and advantages of the proposed invention are:

(a) Reduced complexity and therefore reduced cost in the photo-electronic receiver. Since a two-dimensional focal plane sensor is not necessary, the ability to simultaneously measure image and range estimates is not be tied to a costly effort to develop high resolution photosensor arrays. Measurements can be accomplished with a single high-speed, high-performance photodetector or photomultiplier.

(b) The inventions leverages the advantages of the falling costs of data processing equipment and inexpensive diffractive optical elements.

(c) Elimination of delicate scanning galvanometers. The encoded patterns are generated by illuminating diffractive optical elements fabricated on the surface of transparent or reflective substrates. These substrates will be mounted on rugged computer actuated motors that swiftly pivot or translate the pattern into the correct position.

(d) Relaxed requirements on the collection optics. Since either a single or reduced number of photodetectors are needed, there is no longer a need to form a focal plane image. The emphasis can be shifted from image quality to collection efficiency.

(e) The invention has flexibility in packaging. The illumination, receiving device and data processing device can be integrated into a single package, deployed separately, or packaged in various combinations. For example, it is feasible to operate the illuminator from a remote air platform and collect light locally. In this manner, the active illumination that can draw attention will not reveal the location of the remaining modules of the surveillance unit.

(f) Diffractive elements generating complex spatially varying patterns are relatively easy to design and fabricate. They can be easily integrated into the laser illumination of LADAR systems.

(g) The system can be integrated with conventional scanning approaches to provide enhanced resolution to these system. Thus, this invention can serve as an upgrade for existing technologies.

### Summary of Invention

This invention uses a pulsed (temporally encoded) light source to illuminate an object or scene with a unique sequence of patterns of spatially varying intensities. Since the illumination is well defined in time, range information can be extracted. The reflected light is detected and amplified to form an electronic signal by either a single photo-detector or a small array of photo-detectors. By methodically combining the signals generated by the various illumination patterns and measured by the photodetectors, the reflected light signal from a particular region in the scene can be isolated and separated from signals from other regions. In this manner, the range and reflection intensity (imaging) of each region can be determined. The illuminating pattern set may be designed in a particular fashion to extract resolution or other image features depending on the nature of the use, therefore there are potentially a large, arbitrary number of illumination patterns sets.

### BRIEF DESCRIPTION OF DRAWINGS

FIG. 1 shows a block diagram of the multiplexed, spatially encoded illuminator imaging and ranging system modules.

FIG. 2 shows further details of the illumination module 1000.

FIG. 3 shows further details of the receiver module 3000.

FIG. 4 shows further details of the pattern generator module 1200.

FIG. 5 shows three methods for pattern presentation. FIG. 5A shows a pivoting transparent diffractive optical element array. FIG. 5B shows a translation scanning diffractive optical element array. FIG. 5C shows a stationary dynamically encoded micromirror device array.

FIG. 6 shows an example of four two-dimensional illumination patterns.

FIG. 7 shows an example of the received electronic signal formed from the combination of radiance reflected from various elements in the scene.

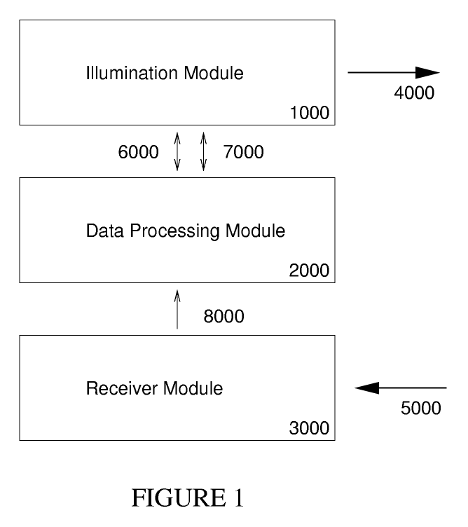

The fundamental modules of the system are shown in the block diagram in FIG. 1. Block 1000 is the illuminator module that produces the dynamically varying, temporarily and spatially encoded light intensity patterns. The illumination module, 1000, may receive control instructions through a channel, 7000, from the data processing module, 2000, to indicate which light pattern it should generate. It may create a time synchronization signal communicated through the channel labeled 6000 to indicate the reference time of the light pulse, or it may receive a synchronization command specifying when to emit the illumination. The radiation pattern emitted is represented by arrow 4000.

Block 2000 is the data processing system that analyzes the collected data received from receiver module, 3000. It calculates range and image information and produces graphical display or numerical analysis. It may communicate in either a unidirectional or bi-directional manner with the illumination module, 1000, through channels 6000 or 7000. It retrieves data for processing from the receiver module, 3000, as suggested by arrow 8000. Although the figure indicates that a single data processor module is used, the processing may be divided between more than one coupled or independent processors.

Block 3000 is the receiver module that collects the reflected light, performs a photo-electric conversion to an electronic signal and performs signal processing to enhance specific signal characteristics. It receives reflected light from the object as specified by arrow 5000 and relays electronic data and signals to the processing module, 2000, through the channel labeled 8000.

Arrow 4000 illustrates that the radiation propagates from the illumination module, 1000, to the object or scene being observed.

Arrow 5000 illustrates that the scene or object reflects a portion of the incident light back to the invention receiver module 3000.

Arrow 6000 indicates that timing synchronization data and commands are exchanged between the illumination module, 1000, and the data processing module, 2000.

Arrow 7000 indicates that a signal is exchanged between module 1000 and module 2000 to indicate which illumination pattern of the pattern set is in use. A dual ended arrow is shown to indicate that either the module 1000 is indicating the current pattern to module 2000, or that module 2000 is instructing module 1000 to select a specified pattern, or that that an instruction and acknowledgement is exchanged between modules 1000 and 2000. In certain embodiments, data representing the generating pattern may be communicated from the processing module 2000 to the illumination module 1000.

Arrow 8000 indicates that the processed signal measured in the receiver module 3000 is provided to the data processing module 2000 for analysis.

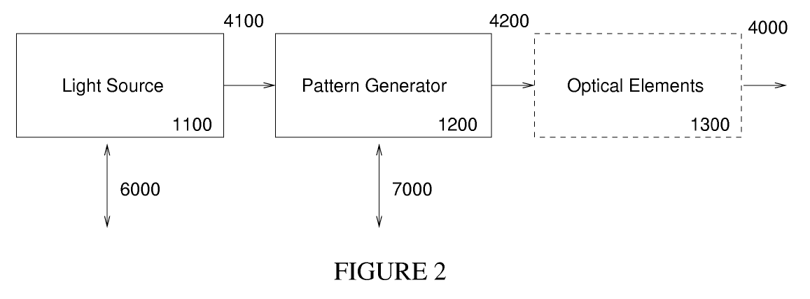

FIG. 2 shows a detailed block diagram of the illumination module 1000. A light source 1100 such as a laser generates the irradiance. This irradiance, 4100, is transferred to and manipulated in the pattern generator module 1200 such that a dynamically changing, spatially encoded light intensity pattern is formed at the object. The output irradiance, 4200, is sent to module 1300 which is an optional set of optical elements which may or may not be needed to assist in directing the light to the scene. For example, the elements may focus the light pulse, 4200, or control the deflection of the beam. The irradiance leaves the system as indicated by arrow 4000. Although the light source could be further decomposed, the nature of the source is not crucial to the this invention and a detailed examination would be dependent on the particular light source chosen. Arrow 6000 indicates that timing synchronization information and commands are exchanged between the light source 1100 and the data processing module, 2000. Arrow 7000 indicates that data and control information regarding the illumination patterns are exchanged between the pattern generator, 1200, and the data processing module, 2000.

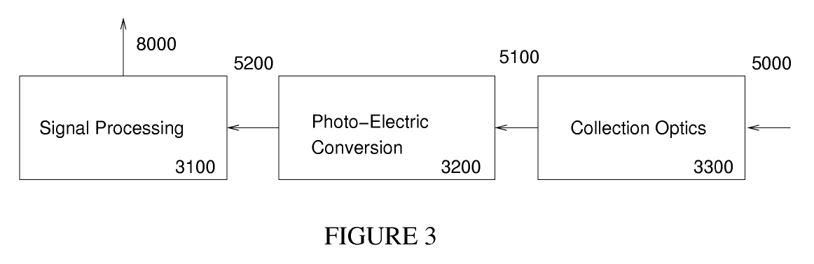

FIG. 3 shows a detailed block diagram of the receiver module 3000. Light 5000 reflected from the distant object is collected by the optical system 3300 and usually focused as indicated by arrow 5100 onto a photosensitive device 3200. The collection optics, 3300, may include a multiplicity of refractive lenses and/or reflective mirrors, plus optical filters that block all light except that which falls within the spectral region of the emitting illuminator. If required, there may also be mechanical shutters or light modulators for blocking light from outside the time interval of interest and apertures for closing the system when the device is not being operated. The photosensitive device, 3200, converts the optical signal into an electronic signal, 5200. The electronic signal, 5200 is then transmitted to the signal processing module 3100 for enhancement. The enhanced signal 8000 is finally transmitted to the data processing module 2000.

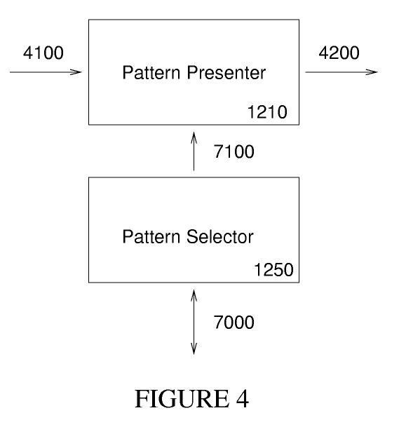

FIG. 4 shows a functional breakdown of the pattern generation module 1200 which is a part of the illumination module 1000. The pattern presenter 1210 is the device that holds the generating pattern that manipulates the light beam such that the spatially encoded illumination pattern is formed at the object. The pattern selector module 1250 is either an electronic or mechanical device that selects which spatial pattern is encoded into the light. In some embodiments, modules 1210 and 1250 may be integrated within a single device. Module 1250 communicates with module 2000 through channel 7000 to determine what pattern is selected for use.

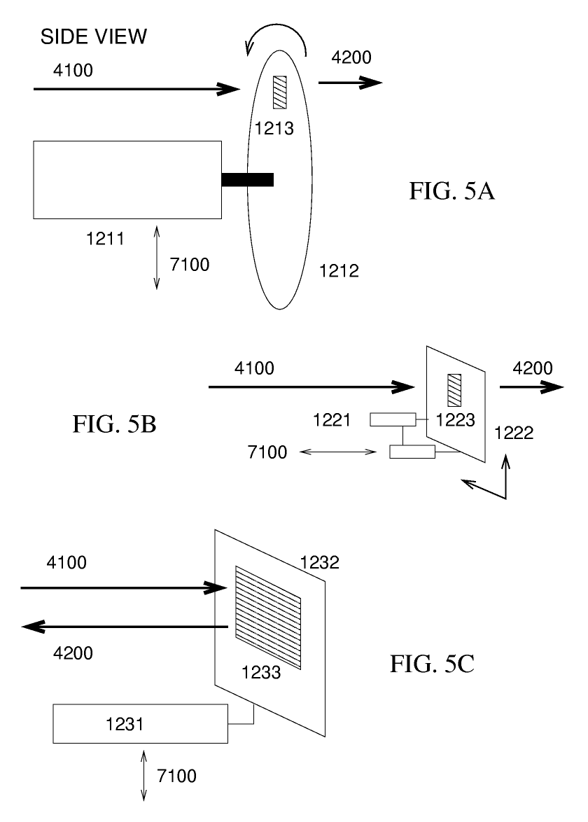

FIG. 5 shows further detail of the pattern presentation module 1200. Illustrated are three embodiments of technology that manipulates the incoming light beam 4100 to form an encoded light beam 4200. Each part of the figure shows a perspective that is viewed primarily from the side and partially to the rear of the piece.

The top mechanism shown by FIG. 5A is composed of a motor and shaft 1211 that pivots an optically transparent, round, disc-shaped element 1212. The element 1212 has a number of pattern generating designs placed on or within the surface. Part 1213 represents one of these generating pattern designs placed in the beam path.

The middle FIG. 5B shows a second embodiment. The motor assembly 1221moves the pattern holder 1222 along two axis independently. The movement is primarily lateral to the light beam 4100. Again, the transparent surface of 1222 is covered with generating pattern designs. One such pattern, 1223, is shown.

The bottom embodiment in FIG. 5C shows a mechanism, 1232, which can reconfigure its generating pattern design, 1233, using an array of micromechanical devices such as micro mirror arrays. In this case, the device is reflective. A data processing element, 1231, is used to store generating patterns and to control the state of device 1232. In each case data and control information is communicated with the data processing module 2000 through channel 7100.

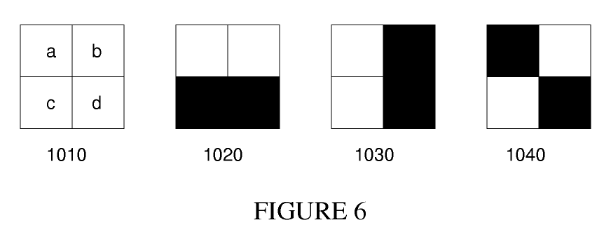

FIG. 6 gives a simple example of a spatial pattern that could be generated by the illuminator module (1000). Pattern 1010 shows a rectangular beam that is subdivided into four regions and labeled parts a, b, c, and d. In this figure, a white box indicates a higher intensity region and a dark box indicates a low intensity region. In pattern 1010, all four regions have high intensities. Patterns 1010, 1020, and 1030 show three other different combinations. This figure is meant to serve as an example. Patterns used in the invention will have greater complex and diversity.

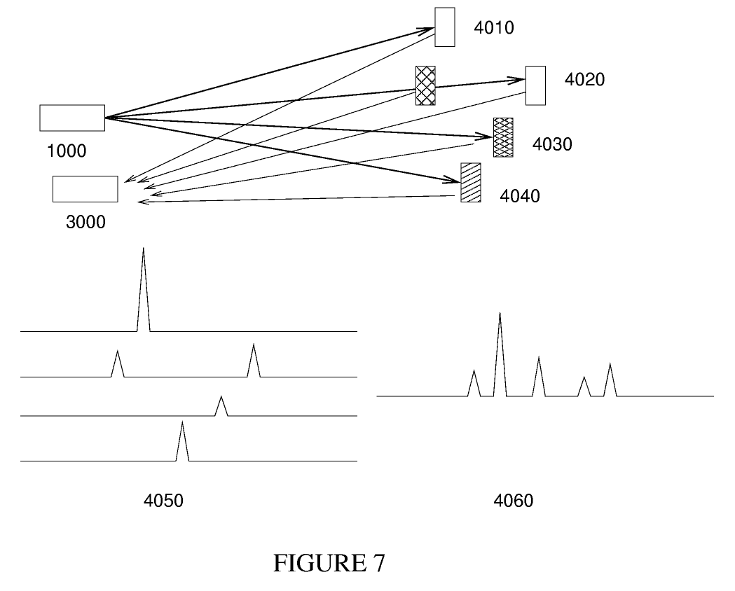

FIG. 7 shows a simple example of the electronic signals that could be received when several scene locations are illuminated simultaneously. Item 1000 is the illumination module emitting four pulsed beams in this example. The top beam hits a highly reflective element, 4010, and produces the top signal in 4050 if only this region is illuminated. Beam 4020 strikes a semi-transparent object and a more distant object. The 2nd signal from the top in 4050 shows how the first object produces a smaller signal due to the partial reflectance, and the second object creates a delayed pulse that is smaller due to the greater distance. Beam 4030 creates a small pulse due its darker color, and beam 4040 creates a intermediate size pulse at an intermediate delay. Since the invention uses a single photodetector, the signals from all beams would be superimposed on each other and appear as the signal represented by 4060.

### Detailed Description

### Fundamental Operation

In order that we may distinguish the spatially encoded light intensity patterns that illuminate the object from the patterns on the physical structure that are used to manipulate the light beam waveform, we will refer to these respectively as the illumination patterns and the generating patterns. A simple example of illumination patterns shown in FIG. 6 parts 1010 through 1040 will be discussed later. The form of the generating patterns will depend on the manner in which the light is manipulated and, in general, may bear no resemblance to the illumination pattern.

The key features of this invention are:

(a) Assembling a pulsed light source (which can be accomplished using commercially available systems).

(b) Assembling a high-speed photo-detector and A/D signal sampling system (which can be accomplished using commercially available equipment).

(c) Choosing and designing the generating patterns corresponding to the illumination pattern (using a variety of methods discussed below).

(d) Affixing the generating patterns to a computer controlled mechanical translation stage or motor (using techniques to be described).

(e) Writing a computer application for controlling the system and acquiring the signal data via a data processing system.

(f) Determining the appropriate combination of signals in order to isolate an image element or other feature (using techniques described below.)

(g) Writing a computer application for combining the signals, analyzing the separated data channels, and presenting the range and/or image information in a manner that can be interpreted by a user.

The invention operates in the following manner: The system selects one particular illumination/generating pattern combination from the available set. The generating pattern may be a permanent structure, such as a microscopic surface-relief pattern etched into a glass-like substrate or a data element that is used to configure a microscopic array of deflective micromirrors. The illuminator module is configured so that the generating pattern is moved into the beam path. A light pulse is generated and the wavefront is modified by the generating pattern element. Next, optional optical elements relay the light toward the object where a structured illumination pattern is produced. Light is reflected by the object and returns to the receiver where it is collected by optics, converted to an electronic signal by a high-speed photodetector, and then sampled and stored by a data processing module. The pulse may be repeated to improve the statistics on the signal. Next, the illumination module selects a new generating pattern and repeats the process. This sequence is repeated with each generating pattern until a suitable number of signals has been collected. The data processing unit then combines the signals in a specific manner until either a signal from an isolated region or other suitable feature has been extracted. This individual signal can then be further analyzed to measure range and or intensity information.

Finally, the image, range, and/or other feature sets of the scene are shown on a graphics display (flat or stereoscopic) in a manner that is understood by a human user or can be interpreted by processing applications that are not necessarily an integral part of this invention.

### Means of Encoding the Illumination

We will describe two means of encoding the light intensity patterns.

The preferred embodiment of this technique is to use diffractive optical elements to manipulate the structure of the light beam's wavefront and thereby redistribute the far-field irradiance energy.

This is accomplished by adding spatially variant phase delay and/or by spatially absorbing radiant energy laterally across the beam cross-section. A second embodiment is to use a spatially variant filter or pattern to absorb radiance energy across the beam cross section and to then use an optical system to re-image this pattern at the location of the object. The first embodiment is preferred because the distant illumination pattern generally does not change with transmitted distance except for scaling with distance, and optical components for shaping the light beam into Gaussian beam are typically suitable. However, the second embodiment may suffer from depth of focus of restrictions throughout the range of operation and will probably require an optical system with better performance.

The generating patterns that modify the wavefront of the light beam such that it forms spatially encoded intensity distributions at the object can be physically realized by several means. FIG. 5 shows several embodiments using either a transparent or reflective substrate with an area of surface relief microstructures. These microstructure are typically just larger than the dimensions of the wavelength of the illuminating light beam. In the top and middle mechanisms, the generating patterns are predetermined and permanently manufactured onto the substrate. The substrate is then either rotated or shifted to select the appropriate pattern. In the lower mechanism, a device such as a micromirror array or an LCD array is used. The generating pattern is then dynamically presented on the device under electronic control. This feature provides the ability to dynamically calculate specific generating patterns that can be tailored to the situation. The drawback is that these micromechanical array devices may have lower spatial resolution then the previous scheme and may therefore generate illumination patterns of less complexity.

### Means of Determining the Generating Patterns

The spatial distribution of the light at the object can typically be calculated using scalar diffraction theory (integrated with an optical analysis of any optional optics), although rigorous couple wave analysis may be needed for very complex and fine structures. The microstructure serves to manipulate the impinging waveform by creating a spatially varying phase delay across the light beam.

As a specific example, one particular scheme would be to form a two-dimensional pattern that is periodically repeated across the pattern presentation substrate. Scalar diffraction theory holds that a regularly spaced array of beams are generated at a substantial distance from the system. This array of beams can be designed with arbitrary intensities. The angular spacing between beams along one dimension, Θ is constant and, for small angles is given by the formula, Θ=λ/P, where λ is the wavelength of the laser light and P is the period size of the basic generating pattern. According to scalar diffraction theory, the relative intensities of the beam array is given by the mathematical Fourier Transform of the structure of the base pattern. A one-dimensional pattern requires a one-dimensional Fourier analysis, while a two-dimensional pattern requires a two-dimensional Fourier analysis.

It should be noted that there are a variety of optical analysis methods for determining how a suitably modified wavefront evolves into an illumination pattern at a distance from the structured element. Some of these elements are referred to in technical literature as (amplitude and phase) gratings, kinoforms, diffractive optical elements, Fresnel and Fourier holograms, and so on. The invention does not rely on a particular method of calculation to determine the structure of the generating pattern. It is only necessary that a set is designed and that the relative combination of signals generated by the illumination be analyzable.

A partial list of devices that be used to create diffractive generating patterns are:

phase modulating diffractive pattern on an optically transparent substrate,

modulating diffractive pattern on an optically reflective substrate,

amplitude modulating diffractive pattern on an optically transparent substrate,

amplitude modulating diffractive pattern on an optically reflective substrate,

combination phase and amplitude modulating diffractive pattern on an optically transparent substrate,

combination phase and amplitude modulating diffractive pattern on an optically reflective substrate,

a micro-mirror device array (amplitude modulation),

an LCD spatial light modulator (amplitude or phase modulation),

a hologram.

The illumination patterns can be chosen arbitrarily or else they can be selected from sets of previously determined patterns or codes. The selection may be based on a specific feature or component for which the user is searching, or it may be based on the mathematical complexity or ease of extraction of the signal analysis. For example, periodic horizontal or vertically aligned bands of light maybe used be used to search for specific Fourier frequency components. Or a coded sequence of binary amplitude patterns, such as Hadamard codes, may be used to decompose the scene from low resolution to high resolution components.

Once the illumination patterns have been selected, various means can be used to determine the corresponding generating patterns. For example, in one configuration a simple Fourier transform of the illuminating pattern can be used to calculate the generating pattern, however, this straight-forward transform typically results in a mixed amplitude and phase modulated structure which is currently difficult to construct.

It is often useful to restrict the diffractive element to either a pure amplitude modulation or pure phase modulation structure and additionally to quantize the phase or amplitude levels to a fixed number of values. In either of these two cases, an optimization process can be used to determine the pattern. We will summarize one optimization method, referred to as the Gerchberg-Saxton technique. Here, the illumination intensity pattern is Fourier transformed into a generating pattern, then the undesired phase or amplitude information is removed, and the resultant pattern is inverse Fourier transformed to recover a resultant illumination pattern. During that step, intensity variations have been unintentionally introduced into the illumination pattern, so the desired amplitude is restored (saving the phase information) and the cycle is repeated. Ideally, the corrections at each of the optimization cycles converge and eventually a suitable generating pattern has been generated.

It should be noted that some schemes for generating spatially encoded illumination may also generate a minor amount of radiance outside the designated pattern region. For example, in a diffractive optical system, it is typical to manipulate the waveform so that between 80% and 95% of the radiant energy is coupled into the desired spots within a confined region of interest. The remaining radiation is typically scattered outside the defined region and the distribution will vary from pattern to pattern. For this reason it may be important to place beam stops or apertures on the outgoing illumination to remove this extraneous light or else to somehow account for the addition of this noise in the processing of the signals. The important point is to note that there a number of methods to adjust for this effect and that the optimal solution will depend on the practical implementation.

### Means of Determining the Decoding Combinations

One means of determining the appropriate combination of signals that reconstructs the radiance from an isolated regions is to begin by representing the complete set of measured signals from all patterns as a vector, s(t) with individual measurements from a specific pattern, sᵢ(t). The signal that we wish to isolate from a localized region is r ⱼ(t) and the full data set from all regions is r(t). Typically, we would chose the range of i to equal the range of j.

Each illumination pattern, Pⱼ determines the radiant energy on a specific scene element by casting spatially varying patterns of intensity. Thus we would write that Pj (intensity pattern) multiplies the vector r(t) (scene element's range response) to create the combined measurement sᵢ(t). In matrix form this can be written as the operation,

P·r(t)=s(t).

The solution to determining each rᵢ(t) is to calculate the inverse matrix, P⁻¹ such that,

r(t)=P⁻¹·s(t).

Thus in general, the sequence or set of patterns should form a matrix representation that is invertible.

### Example of a Decoding Sequence

The data processor is used to extract and isolate the intensity and ranging information for a specific spatial region using defined combinations of each of the collected signals. We will illustrate this concept by means of a simple example.

FIG. 6 will help illustrate how a sequence of patterns can be used to extract the signal from an isolated region. Here, we use a two-dimensional 2×2 array, although a one-dimensional pattern or a non-square two-dimensional pattern could also be applied. We will assume binary intensity levels (a low intensity and high intensity level), however, multiple intensity levels and non-uniform intervals could also be applied.

We will label the four regions as a, b, c, and d. The signal that we would receive if we isolated “a” would be a(t), from “b” would be b(t), etc. When the patterns are projected on the scene, a, b, c, and d, will hold range and intensity information from specific elements in the scene. The task will therefore be to isolate these values.

When the scene is illuminated, a signal will be measured that contains contribution from a, b, c, and d. We will designate the pattern associated signals for as A(t) for the combined signal from the first pattern, B(t) as the combined signal from the second pattern, etc.

We will use the pattern values from the figure equating a 1 to a white region and a 0 to a dark region. In the first pattern, all four regions are equally illuminated with a high intensity beam. Thus signal could be written:

A(t)=a(t)+b(t)+c(t)+d(t).

The signal from the second pattern would be:

B(t)=a(t)+b(t).

The signal from the third pattern would be:

C(t)=a(t)+c(t).

and the signal generated by the fourth pattern would be:

D(t)=b(t)+c(t).

The objective is to combine elements of A(t), B(t), C(t), and D(t)in order to recover a(t), b(t), c(t), d(t). From these results we will be able to determine range and image information for this 2×2 area.

One method to determine isolated range and image information is to cast the data as a matrix operation. Combining the preceding relations, we would then have:

$$( \begin{matrix}1 & 1 & 1 & 1 \\ 1 & 1 & 0 & 0 \\ 1 & 0 & 1 & 0 \\ 0 & 1 & 1 & 0\end{matrix} ) ( \begin{matrix}a ( t ) \\ b ( t ) \\ c ( t ) \\ d ( t )\end{matrix} ) = ( \begin{matrix}A ( t ) \\ B ( t ) \\ C ( t ) \\ D ( t )\end{matrix} )$$

Using linear algebraic methods, we could determine the solution to be:

$$( \begin{matrix}a ( t ) \\ b ( t ) \\ c ( t ) \\ d ( t )\end{matrix} ) = 1 / 2 ( \begin{matrix}0 & 1 & 1 & - 1 \\ 0 & 1 & - 1 & 1 \\ 0 & - 1 & 1 & 1 \\ 2 & - 1 & - 1 & - 1\end{matrix} ) ( \begin{matrix}A ( t ) \\ B ( t ) \\ C ( t ) \\ D ( t )\end{matrix} )$$

Thus, the signal from region “a” would be given by:

a(t)=½·(B(t)+C(t)−D(t))

the signal from region “b” would be given by:

b(t)=½·(B(t)−C(t)+D(t))

the signal from region “c” would be given by:

c(t)=½·(−B(t)−C(t)+D(t))

and the signal from region “d” would be given by:

d(t)=½·(2A(t)−B(t)−C(t)−D(t)

### Means of Determining the Range

Ideally, the resultant processed and analyzed signal will contain a single, short duration pulse that is a delayed version of the intensity modulation of the source laser pulse. The range to the object can then be determined by calculating the time difference between the source pulse and signal pulse, dividing by the speed of light in air (or appropriate media), and correcting for system geometry. In a simple configuration where illuminator and sensor are located relatively close compared to the object distance, the correction may be to divide the calculation by a factor of two. Configurations where illuminator and sensor are not collocated will require additional corrections.

If semi-transparent objects fall along the ray from the illuminator to the target, a series of additional pulses may appear in the isolated signal. Additionally, if a considerable number of patterns are used, or if there is movement in the scene, or if the relative signal power has fallen to a level comparable to the noise inherent in the system, then a number of extraneous pulses or level fluctuations may appear in the signal. It is task of the analysis application to determine whether or not to filter these potentially spurious results.

### Means of Determining the Reflection Intensity

If the isolated signal pulse is relatively strong relative to system noise, then integrating the pulse strength indicates the relative intensity of the reflection from the region. It will likely be necessary to scale the measurement by range to account for reduced light collected at greater distances. Assigning these intensities to a grid will generate an image of the scene.

### Using the Invention to Enhance Prior Art

It is also possible to create a hybrid system that uses this invention in addition to techniques from prior art. The reason to consider such a combination is due to the reduced signal-to-noise ratio and large data sets that might be collected using the proposed invention when attempting to isolate individual signals when large collections are attempted. For example, a two-dimensional 4×4 illuminating pattern might require 16 measurements, whereas a 32×32 pattern might require a data set that is 64 times larger and the relative signal component reduced by a factor of 64 relative to the full strength. Given the noise inherent in a practical signal amplification system, there will likely be a configuration where higher spatial resolution leads to worse reconstruction performance unless greater laser power and higher performance photodetectors are used.

One embodiment would be to integrate the invention with a system that uses a set of computer actuated mirrors that operates by deflecting the beam in order to provide additional scanning resolution. The mirror system would be contained in module 1300 of the illumination module as illustrated in FIG. 2.

Currently, mirror scanning systems operates at a slower speed than the dynamically encoding scheme. Therefore the mirror scanner might be chosen to provide the coarse pointing granularity with fine or interscan imaging generated by the proposed invention. In the combined system, the full multiplexed analysis of the invention could occur at a specific mirror orientation, and then repeated as required at additional orientations. In this manner, the resolution of the system could be enhanced, or the scanning speed of the prior art system could be significantly improved. Full resolution would be created by combining the calculated range and intensities from all data sets.

### Additional Feature of the Invention

One important consequence of this invention is that the illuminator and the detector can be separated by a significant distance and that it is not necessary for the receiver's collection optics to be able to resolve an image of the scene. Therefore the receiver may collect light from a remote location and still simultaneously recover imaging and ranging information that would not be possible from a focal plane imager.

### Conclusion, Ramifications and Scope

This invention introduces an economical and robust means of determining range and image information from a scene using actively encoded illumination, a single element photodetector and data processing equipment. It's chief advantage over prior-art focal plane solutions is shifting the complexity from the expensive sensor module to the illumination and data processing modules where alternative uses of similar technology is rapidly reducing costs. The invention also has advantages over traditional laser scanning devices because it replaces delicate galvanometers with simpler computer actuated motors and translators. Ultimately, the integration of micro-mirror arrays and other micro-actuated arrays will totally eliminate the need for large-scale mechanical parts.

This invention uses an illuminator that generates a sequence of encoded radiant patterns and an associated data processing module that analyzes the multiplexed data sets to determine region specific range and imaging information. By using a single element photodetector, the system has a large dynamic sensitivity and achieves significantly better performance than conventional photosensor arrays.

This referenced illumination system can be inexpensively manufactured, can withstand rugged handling, and can be packaged into an inexpensive and compact system. These advantages promote the possibility of hand-held LIDAR imagers which will encourage their use for rapid 3D scene and object reconstruction or integration into miniature air reconnaissance vehicles. Since the spatially encoded patterns will be sequenced at a high rate, the projected illumination will likely appear to be a uniform intensity beam to the human eye. Therefore the instrument could very well serve a dual function as flashlight and range/imaging camera.

Finally, this technique can also be integrated with prior art line scan techniques to dramatically enhance their spatial resolution and functionality.

Since the invention operates with a single photodetector, it can be designed to operate over a large spectral range. Indeed, if the photodetector module is constructed to be interchangeable, then the system can operate at multiple spectral regions. Also, the photodetector/photomultiplier can be designed to operate over a large dynamic range providing a significant advantage over complex sensor arrays.

Although we have suggested that the scope of the invention includes characterization of human scale objects (i.e., meters to 10's of meters), the invention can scale to either microscopic scale regions or larger scale scenes if the accuracy of the temporal analysis can be maintained. In addition, the invention is not limited to the ordinary visual spectrum and can be applied to other radiant sources provided the temporal characteristics of the radiant pulse can be adequately controlled.

1. I claim a method for illuminating a scene and analyzing the reflected radiance comprising:
(a) an illumination device having a means of generating and directing radiance toward a scene where said radiance is composed of a selective set of time sequential, spatially encoded intensity patterns where the radiance has, in addition, a resolvable temporal structure,
(b) a receiving device having a means of optically collecting the reflected radiance from said scene and converting said reflected radiance into an analyzable signal,
(c) a means of controlling and maintaining the synchronization between generation of said radiance patterns and said collected signal,
(d) a data processor device having a means to collect and store multiple sets of said signals,
(e) said data processor having in addition a program providing a means to combine various sets of signals in a prescribed manner,
whereby a representation of said scene is determined.

2. The device in claim 1 wherein the representation of said scene is a data set that can be used to render a three dimensional model of said scene.

3. The device in claim 1 wherein the representation of said scene is a data set separable into range estimations and intensity values of elements in said scene.

4. The device in claim 1 wherein the representation of said scene is an array of intensity values that can be interpreted as an image.

5. The device in claim 1 wherein the representation of the scene is a data set conforming to a prescribed manner of rendering an image.

6. The device in claim 1 wherein said radiance source is a laser.

7. The device in claim 1 wherein said radiance source is composed of multiple monochromatic sources and said scene representation includes additional spectral information.

8. The device in claim 1 wherein said radiance is emitted as a pulse with a duration of about a few nanoseconds.

9. The device in claim 1 wherein said radiance is a series of pulses and the pulse repetition rate changes monotonically during the interval of one pattern.

10. The device in claim 1 wherein said illumination device generating the said encoded patterns selects from a set of predetermined patterns.

11. The device in claim 1 wherein the set of patterns are adaptively determined concurrent with analysis.

12. The device in claim 1 wherein the generating patterns that create said encoded intensity patterns are microscopic surface relief elements which impart a spatially variant phase delay to the light beam to produce calculable diffractive optical effects.

13. The device in claim 1 wherein the generating patterns that create said encoded intensity patterns are microscopic spatial light modulating elements that produce calculable diffractive optical effects.

14. The device in claim 1 wherein the generating patterns that create said encoded intensity patterns are holographically recorded patterns.

15. The device in claim 1 wherein the generating patterns that create said encoded intensity patterns are inscribed on a surface and pivoted into position.

16. The device in claim 1 wherein the generating patterns that create said encoded intensity patterns are inscribed on a surface and translated into position.

17. The device in claim 1 wherein a reconfigurable micro-structured device presents the generating patterns that create said encoded intensity patterns.

18. The device in claim 1 wherein said radiance is directed toward said scene using an appropriate combination of lenses, reflectors, fiber optics, and optical elements.

19. The device in claim 1 wherein the said receiver is an electro-optic device that converts radiant intensity into an electronic signal.

20. The device in claim 1 wherein said receiving device has a means of conditioning said signal for improved analysis.

21. The device in claim 1 wherein said illumination device and said receiver device and said data processing device are distinct and separated units.

22. The device in claim 1 wherein said illumination module and said receiver device and said data processing device are combined together into a unified package.

23. The device in claim 1 wherein said signals are analyzed at multiple discrete time intervals in order to extract range estimates.

24. The device in claim 1 wherein said signals are mixed with the monotonically increasing pulse train in order to generate an interference signal that indicates a range estimate.
